(19) United States
(12) Patent Application Publication
(10) Pub. No.: US 2005/0210233 A1
(43) Pub. Date: Sep. 22, 2005

(54) System and method for updating a basic Input/Output system program

(75) Inventors: Gui-Hua Tang, Shenzhen (CN); San-Yi Shu, Shenzhen (CN); Yi-Ching Weng, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/954,056

(22) Filed: Sep. 29, 2004

(30) Foreign Application Priority Data
Mar. 19, 2004 (TW) 93107401

(51) Int. Cl. G06F 9/00

(52) U.S. Cl. 713/100

(57) ABSTRACT

Basic Input/Output System (BIOS) program updating system applies a multi-level architecture including an application level, a driver level, a hardware abstraction level, and a hardware platform. The application level includes a user interface (10) for receiving a binary file recording a new BIOS program from a user, and for generating a command signal for updating a current BIOS program after receiving the binary file. The hardware abstraction level includes a BIOS (13) for updating the current BIOS program stored in a flash memory (14) with the new BIOS program recoded in the binary file. The BIOS program updating system can reduce the complexity of the hardware abstraction level, and is compatible with different types of BIOSs. A related method is also provided.

### BACKGROUND OF THE INVENTION

1. Field of the Invention

The present invention relates to systems and methods for updating computer system parameters, and particularly to a system and method which can update a Basic Input/Output System (BIOS) program of a computer system.

2. Related Art of the Invention

When a computer system is powered on and “booted,” the computer system must ensure that all computer components are functional, and subsequently load the operating system. These functions are performed by code referred to as the Basic Input/Output System (“the system BIOS”). The system BIOS also contains data and instructions that enable the operating system to access system hardware. The system BIOS is stored in a system memory, typically in a non-volatile memory such as a flash memory. During booting, the system BIOS firstly performs a Power On Self Test (POST), then proceeds to load the operating system. Following successful loading of the operating system, the user is able to utilize all the features and functionality offered by or through the operating system.

With the ongoing development of computer technology, the system BIOS must be updated to take advantage of new BIOS features as they become available, and to enable the system BIOS to support new system hardware. Updating is also necessary if problems with the system BIOS are detected. A traditional method for updating the system BIOS is implemented under a DOS (disk operating system) system. An operator types in commands through a character user interface (CUI) of the DOS system, and updates the BIOS with the BIOS programs provided by a software supplier. The method varies according to the types of BIOS programs being used and being introduced. That is, the method has poor currency and cross-BIOS compatibility. Furthermore, typing in commands through a CUI one character after another is bothering work and requires that the operator owns relative professional knowledge.

Thus there is a need for a system and method which applies multi-level architecture to update the BIOS under a Windows system and overcome the abovementioned disadvantages.

### SUMMARY OF THE INVENTION

Accordingly, a main objective of the present invention is to provide a system and method for readily and conveniently updating a BIOS (Basic Input/Output System) program in a computer system.

To accomplish the above object, a BIOS program updating system (hereinafter “the system”) in accordance with a preferred embodiment of the present invention is provided herein. The system applies a multi-level architecture including an application level, a driver level, a hardware abstraction level, and a hardware platform. The application level comprises a user interface and a Dynamic Link Library (DLL); the driver level comprises a driver model; the hardware abstraction level comprises a flash memory and a Basic Input/Output System (BIOS); and the hardware platform comprises a South Bridge and a Central Processing Unit (CPU). The user interface is used for displaying information on BIOS programs, receiving binary files recording new BIOS programs from users, and generating command signals for updating the BIOS programs. The information on BIOS programs includes information on a current BIOS program, and information on the new BIOS programs recorded in the binary files. The DLL is used for transmitting the command signals received from the user interface to the driver model. The driver model is used for receiving the command signals, and transmitting the command signals to the BIOS. The flash memory is used for storing the current BIOS program. The BIOS contains a BIOS updating module, which is used for updating the current BIOS program in the flash memory with a new BIOS program recorded in a received binary file. The South Bridge is used for connecting the BIOS with the CPU. The CPU is used for controlling the BIOS to implement the BIOS program updating function.

Further, the present invention provides a method for updating a BIOS program, the method comprising the steps of: (a) storing a current BIOS program of a BIOS in a flash memory; (b) receiving from a user at a user interface a binary file recording a new BIOS program, and generating a command signal for updating the current BIOS program; (c) receiving the command signal at a Dynamic Link Library; (d) receiving the command signal from the Dynamic Link Library at a driver model; (e) receiving the command signal from the driver model at a BIOS, and examining the validity of the binary file; and (f) updating the current BIOS program in the flash memory with the new BIOS program if the binary file is valid.

The system for updating a BIOS program can reduce the complexity of the hardware abstraction level, and is compatible with different types of BIOSs.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware and software infrastructure of a BIOS program updating system in accordance with the preferred embodiment of the present invention; and

FIG. 2 is a flowchart of a preferred method of implementing the BIOS program updating system of FIG. 1.

### DETAILED DESCRIPTION OF THE PREFERRED EMBODIMENT

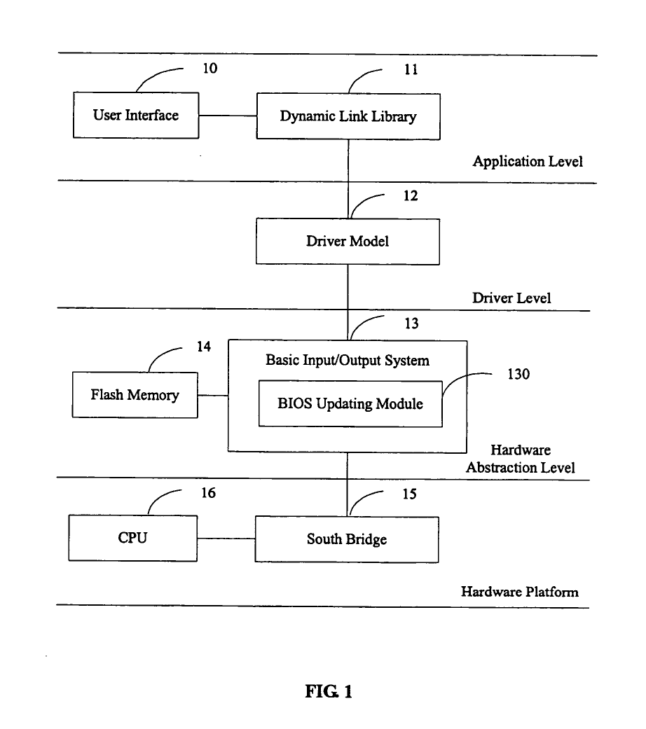

FIG. 1 is a schematic diagram of hardware and software infrastructure of a BIOS program updating system (hereinafter “the system”) in a computer system in accordance with the preferred embodiment of the present invention. The system applies a multi-level architecture including an application level, a driver level, a hardware abstraction level, and a hardware platform. The application level comprises a user-friendly interface 10 and a Dynamic Link Library (DLL) 11. The driver level comprises a driver model 12. The hardware abstraction level comprises a Basic Input/Output System (BIOS) 13 and a flash memory 14. The BIOS 13 comprises a BIOS updating module 130. The hardware platform comprises a South Bridge 15 and a Central Processing Unit (CPU) 16. The user interface 10, which gives users a direct view of updating BIOS programs, is used for displaying information on the BIOS programs, receiving binary files recording new BIOS programs from the users, generating command signals for updating the BIOS programs, and transmitting the command signals to the DLL 11. Information on each BIOS program comprises a code of a manufacturer, an ID and a size of a current BIOS program, and a name, location, size and update time of a new BIOS program. The DLL 11 is used for receiving the command signals from the user interface 10, and transmitting the command signals to the driver model 12. The driver model 12 is used for receiving the command signals from the DLL 11, and transmitting the command signals to the BIOS 13. The BIOS updating module 130 is used for updating a current BIOS program stored in the flash memory 14 with a new BIOS program recorded in a received binary file. The flash memory 14 is used for storing the current BIOS program. The South Bridge 15 is used for connecting the BIOS 13 and the CPU 16. The CPU 16 is used for controlling the BIOS 13 to implement the BIOS program updating function.

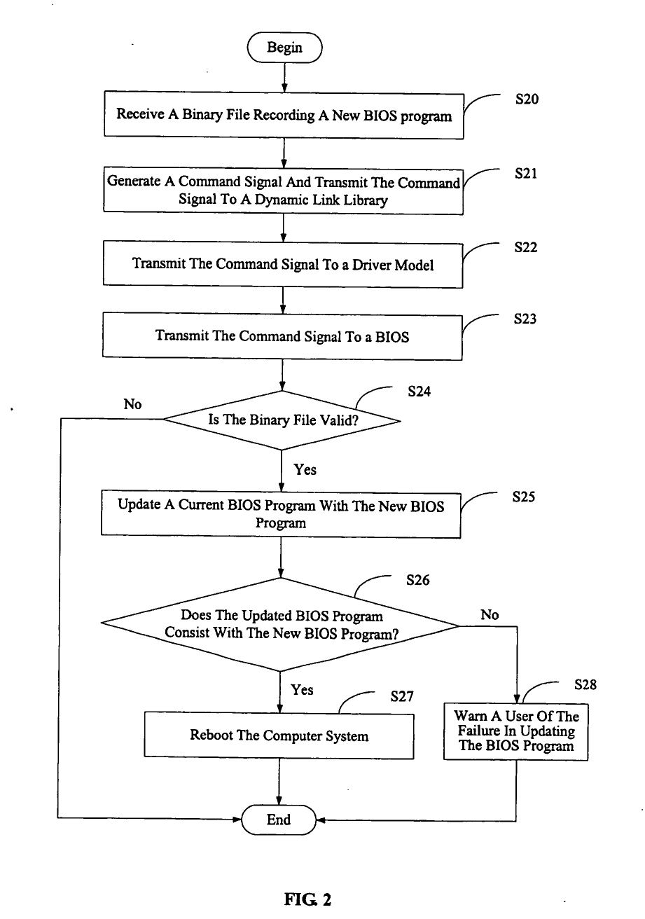

FIG. 2 is a flowchart of a preferred method of implementing the BIOS program updating system in the computer system. In step S20, the user interface 10 receives a binary file recording a new BIOS program from a user. In step S21, the user interface 10 generates a command signal for updating the BIOS program stored in the flash memory 14, and transmits the command signal to the DLL 11. In step S22, the DLL 11 transmits the command signal to the driver model 12. In step S23, the driver model 12 receives the command signal, and transmits the command signal to the BIOS 13. In step S24, the BIOS 13 examines whether the binary file is valid according to the size of the binary file, and by determining whether the new BIOS program recorded in the binary file matches with the motherboard used in the computer system. If the binary file is invalid, the procedure is ended. If the binary file is valid, in step S25, the BIOS updating module 130 updates the BIOS program stored in the flash memory 14 with the new BIOS program recorded in the binary file according to the command signal and under the control of the CPU 16. In step S26, the BIOS 13 checks whether the updated BIOS program in the flash memory 14 consists with the new BIOS program recorded in the binary file under the control of the CPU 16. If the updated BIOS program in the flash memory 14 consists with the new BIOS program recorded in the binary file, in step S27, the computer system reboots itself, whereupon the procedure is ended. If the updated BIOS program in the flash memory 14 does not consist with the new BIOS program recorded in the binary file, in step S28, the computer system warns the user of the failure in updating the BIOS program, whereupon the procedure is ended.

The system for updating a BIOS program can reduce the complexity of the hardware abstraction level, and is compatible with different types of BIOSs.

Although the present invention has been specifically described on the basis of a preferred embodiment and preferred method, the invention is not to be construed as being limited thereto. Various changes and modification may be made to the embodiment and method without departing from the scope and spirit of the invention.

1. A Basic Input/Output System (BIOS) program updating system applying a multi-level architecture, the BIOS program updating system comprising:
an application level, comprising:
a user interface for receiving from a user a binary file which records a new BIOS program, and for generating a command signal for updating a current BIOS program;
a driver level, comprising:
a driver model for transmitting the command signal generated by the user interface; and
a hardware abstraction level, comprising:
a flash memory for storing the current BIOS program; and
a BIOS, comprising:
a BIOS updating module for updating the current BIOS program in the flash memory with the new BIOS program recorded in the binary file.

2. The BIOS program updating system according to claim 1, further comprising a hardware platform.

3. The BIOS program updating system according to claim 2, wherein the hardware platform comprises a Central Processing Unit for controlling the BIOS to update the BIOS program in the flash memory with the BIOS program recorded in the binary file.

4. The BIOS program updating system according to claim 3, wherein the hardware platform further comprises a South Bridge for connecting the Central Processing Unit with the BIOS.

5. The BIOS program updating system according to claim 1, wherein the application level further comprises a Dynamic Link Library for transmitting the command signal generated by the user interface to the driver model.

6. The BIOS program updating system according to claim 1, wherein the BIOS is also for receiving the command signal generated by the user interface from the driver model, and examining a validity of the binary file.

7. The BIOS program updating system according to claim 6, wherein the BIOS examines the validity of the binary file according to the size of the binary file, and by determining whether the BIOS program in the binary file is correct.

8. A Basic Input/Output System (BIOS) program updating method, comprising the steps of:
storing a current BIOS program of a BIOS in a flash memory;
receiving from a user at a user interface a binary file recording a new BIOS program, and generating a command signal for updating the current BIOS program;
receiving the command signal at a Dynamic Link Library;
receiving the command signal from the Dynamic Link Library at a driver model;
receiving the command signal from the driver model at a BIOS, and examining a validity of the binary file; and
updating the current BIOS program in the flash memory with the new BIOS program if the binary file is valid.

9. The BIOS program updating method according to claim 8, wherein the BIOS examines the validity of the binary file according to the size of the binary file.

10. The BIOS program updating method according to claim 8, wherein the BIOS examines the validity of the binary file by determining whether the new BIOS program matches a motherboard used in a current associated computer system.

11. A Basic Input/Output System (BIOS) program updating method, comprising the steps of:
providing a user-friendly interface;
acquiring information of a current BIOS program of a BIOS in a computer system;
acquiring information of a new BIOS program by input said information via said interface;
generating a command signal through a Dynamic Link Library;
driving update of said BIOS program by replacing said current BIOS program with said new BIOS program in case of confirmation of validity of said new BIOS program; and
confirming completeness of said update before rebooting said computer system.

12. The BIOS program updating method according to claim 11, wherein said update is driven through a driver model.
